(19) United States
(12) Patent Application Publication
(10) Pub. No.: US 2002/0080277 A1
(43) Pub. Date: Jun. 27, 2002

(54) Broadcast program recording apparatus and method for recording broadcast programs

(75) Inventors: Hiroshi Kida, Fukuroi-shi (JP); Masayoshi Murayama, Fukuroi-shi (JP); Tsutomu Ohtani, Fukuroi-shi (JP); Masaaki Saito, Fukuroi-shi (JP); Ichiro Miyake, Tokorozawa-City (JP); Tsutomu Takahashi, Tokorozawa-City (JP); Kenichiro Tada, Tokorozawa-City (JP); Yasuyuki Noda, Tokorozawa-City (JP); Gaku Yamamura, Tokorozawa-City (JP); Kazutomo Watanabe, Tokorozawa-City (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation and Shizuoka Pioneer Corporation

(21) Appl. No.: 10/012,366

(22) Filed: Dec. 12, 2001

(30) Foreign Application Priority Data
Dec. 15, 2000 (JP) 2000-382379

(51) Int. Cl. H04N 7/00; H04N 11/00

(52) U.S. Cl. 348/553; 348/460

(57) ABSTRACT

A broadcast program recording apparatus and a recording method of a broadcast program, in which a broadcast program which a user watches periodically can be automatically recorded without performing a timer recording setting. Data of channel number, broadcast date, and broadcast time zone of the received broadcast program are additionally stored into a received program history memory in correspondence to each other. A channel number of a broadcast program having a broadcast date that is precedent to today's date by a predetermined number of days and a broadcast time zone that coincides with the present time is searched for from the received program history memory. A station selection control operation to control the receiving part is performed to receive a broadcast wave of the searched out channel number, to start the recording of the broadcast program received by the recording part.

### BACKGROUND OF THE INVENTION

1. Field of the Invention

The invention relates to a broadcast program recording apparatus for recording programs provided by television broadcast or the like.

2. Description of Related Art

Television programs are organized by the present television broadcast stations frequently in such a way that a series of programs (for example, a series of TV dramas or the like) under the same title are broadcasted in the same time zone on the same day of the week at intervals of one week. The viewers therefore customarily watch a television every same day of the week in a predetermined time zone on that day of the week.

In this case, if the user cannot watch the television in that time zone, he/she may record a program of his/her preference onto a video recording medium by using a timer recording function of a video recorder.

When using the timer recording function, however, a recording reserving operation for previously setting a program which the user wants to record has to be done by the user. This has been a problem because the setting operation itself is rather cumbersome. Even when the user is in a situation that allows him/her to watch the television in that time zone so that the timer recording is unnecessary, if he/she forgets to watch the television he/she will overlook the program which he/she wanted to watch.

### Objects and Summary of the Invention

The invention has been made to solve the problem described above and it is an object of the invention to provide a broadcast program recording apparatus and a recording method of a broadcast program, in which a broadcast program which a user watches periodically can be automatically recorded without the need of a reservation by the timer recording function.

According to a first aspect of the invention, there is provided a broadcast program recording apparatus for recording a broadcast program, comprising: a receiving part for receiving a broadcast wave of a selected channel and demodulating the broadcasted program; a recording part for recording the broadcast program onto a recording medium in response to a recording start command; a received program history memory for additionally storing data representing channel number, broadcast date, and broadcast time zone of the broadcast: program received and demodulated by the receiving part in correspondence to each other; a searching part for searching the received program history memory for a channel number of a broadcast program having a broadcast date that is the same as a date preceding today's date by a predetermined number of days and a broadcast time zone that coincides with the present time; and a history recording control part for performing a station selection control operation to control the receiving part to receive the broadcast wave of a channel of the channel number searched out by the searching part and transmitting the recording start command to the recording part.

According to a second aspect of the invention, there is provided a broadcast program recording apparatus for recording a broadcasted program, comprising: a recording part having a recording medium on which a ring buffer area and a memory area have been formed; a receiving part for receiving a broadcast wave of a selected channel and demodulating the broadcast program; a received program history memory for additionally storing data representing channel number, broadcast date, and broadcast time zone of the broadcast program received and demodulated by the receiving part in correspondence to each other; a searching part for searching the received program history memory for a channel number of a broadcast program having a broadcast date that is precedent to today's date by a predetermined number of days and a broadcast time zone that coincides with the present time; and a history recording control part for performing a station selection control operation to control the receiving part to receive the broadcast wave of a channel of the channel number searched out by the searching part and making a recording control of the recording part so as to record the broadcast program obtained by receiving by the receiving part into the ring buffer area.

According to a third aspect of the invention, there is provided a recording method of a broadcast program in a broadcast program recording apparatus having a receiving part for receiving a broadcast wave of a selected channel and demodulating the broadcast program and a recording part for recording the broadcasted program onto a recording medium in response to a recording start command, comprising: a received program history storing step of additionally storing data representing channel number, broadcast date, and broadcast time zone of the broadcast program received and demodulated by the receiving part into a memory in correspondence to each other; a searching step of searching the channel corresponding to the broadcast program having a broadcast date that is precedent to today's date by a predetermined number of days and a broadcast time zone that coincides with the present time from the memory; and a history recording control step of making a station selection control operation to control the receiving part to receive the broadcast wave of a channel of the channel number searched out by the searching step and transmitting the recording start command to the recording part.

According to a fourth aspect of the invention, there is provided a recording method of a broadcast program in a broadcast program recording apparatus having a receiving part for receiving a broadcast wave of a selected channel and demodulating the broadcasted program and a recording part having a recording medium on which a ring buffer area and a memory area have been formed, comprising: a received program history storing step of additionally storing data representing channel number, broadcast date, and broadcast time zone of the broadcast program received and demodulated by the receiving part into a memory in correspondence to each other; a searching step for searching the memory for a channel number of a broadcast program having a broadcast date that is precedent to today's date by a predetermined number of days and a broadcast time zone that coincides with the present time; and a history recording control step for performing a station selection control operation to control the receiving part to receive the broadcast wave of a channel of the channel number searched out by the searching step and performing a recording control of the recording part so as to record the broadcast program obtained by receiving by the receiving part into the ring buffer area.

### BRIEF DESCRIPTION OF THE DRAWINGS

FIG. 1 is a diagram showing an internal construction of a hard disk recorder 100 as a broadcast program recording apparatus according to the invention;

FIG. 2 is a diagram showing a ring buffer area and a memory area in a hard disk 120 and the recording and reproducing operations in the ring buffer area;

FIG. 3 is a diagram showing an example of received program history information RC which is additionally written into a received program history memory 23;

FIG. 4 is a diagram showing an example of recorded program information RH which is additionally written into a recorded program information memory 24;

FIG. 5 is flowchart showing a history recording control routine;

FIG. 6 is a diagram showing an example of a history recording execution confirmation message image;

FIG. 7 is a diagram showing an internal construction of a hard disk recorder 100′ according to another embodiment of the invention; and

FIG. 8 is a diagram showing a history recording control routine which is executed by the hard disk recorder 100′ shown in FIG. 7.

### DETAILED DESCRIPTION OF THE PREFERRED EMBODIMENTS

An embodiment of the invention will be described in detail below with reference to the accompanying drawings.

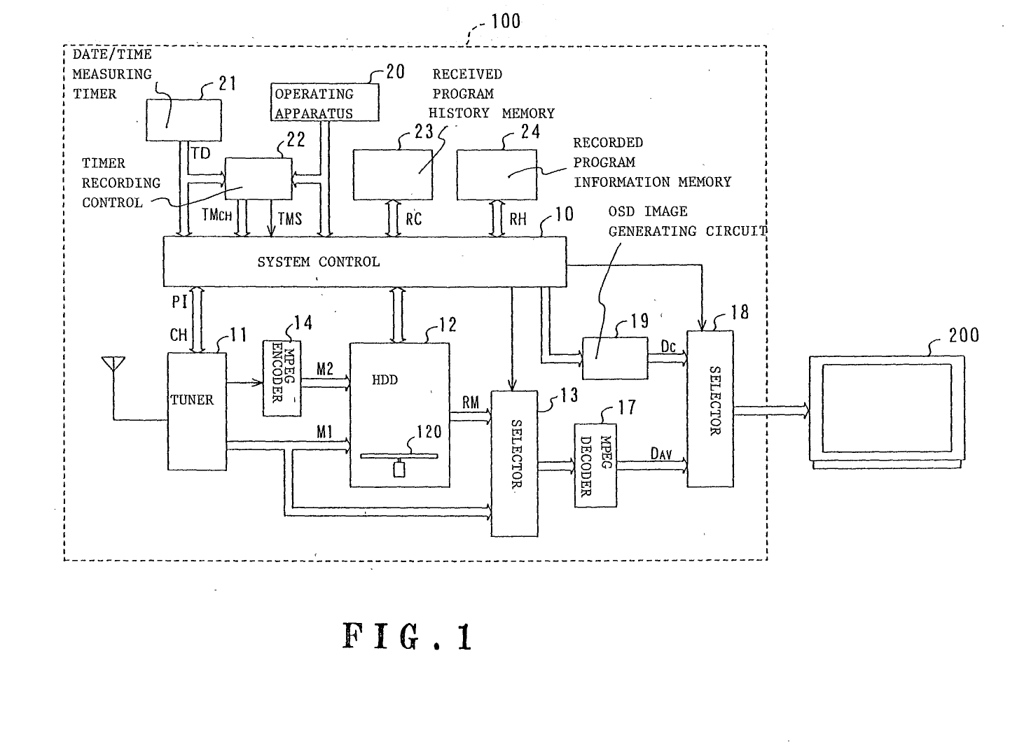

FIG. 1 is a diagram showing an internal construction of a hard disk recorder 100 as a broadcast program recording apparatus according to the invention.

The hard disk recorder 100 can record and reproduce a broadcast program received by a tuner onto/from a hard disk instead of a video tape.

In FIG. 1, a tuner 11 receives a digital broadcast wave of a channel according to a channel designation signal CH supplied from a system control circuit 10. In this operation, the tuner 11 obtains an MPEG (Moving Picture Experts Group) signal by demodulating the received digital broadcast wave and supplies it as an MPEG signal M1 to a hard disk drive (HDD) 12 and a selector 13, respectively. Furthermore, in this process, the tuner 11 extracts information that represents the name, broadcast date, broadcast start time, broadcast end time, and channel number of the received program from an electronic program guide information signal multiplexed to the received broadcast wave and supplies it as received program information PI to the system control circuit 10. When the channel designation signal CH to designate a channel of analog television broadcast (NTSC system, PAL system, or SECAM system) is supplied, the tuner 11 receives an analog television broadcast wave of the designated channel. In this case, the tuner 11 supplies a television signal obtained by demodulating the received analog television broadcast wave to an MPEG encoder 14. Further, the tuner 11 extracts the information representing the name, broadcast date, broadcast start time, broadcast end time, and channel number of the received broadcast program from the electronic program guide information signal and supplies it as received program information PI to the system control circuit 10. The MPEG encoder 14 performs an MPEG encoding process to the TV signal and supplies a resultant signal as an MPEG signal M2 to the HDD 12.

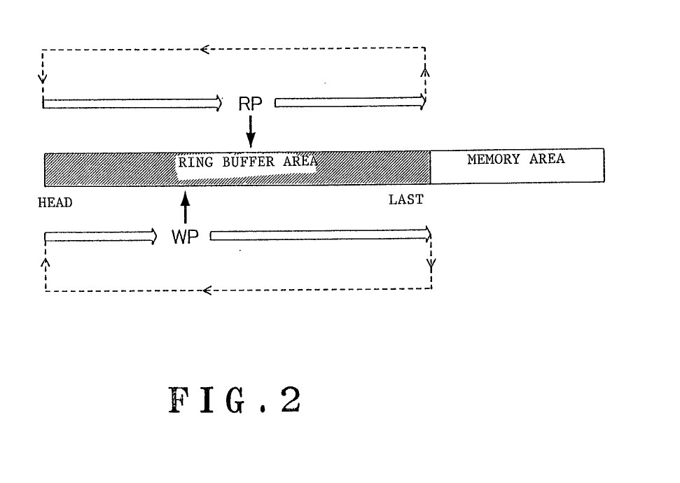

The HDD 12 records the MPEG signal M1 or M2 into a ring buffer area or a memory area on a hard disk 120 as shown in FIG. 2 in response to a recording command signal supplied from the system control circuit 10. The HDD 12 reads out the MPEG signal recorded in the ring buffer area or memory area, reproduces it in response to a reproducing command signal supplied from the system control circuit 10, and supplies it as a reproduction MPEG signal RM to the selector 13. In addition, the broadcast program selected as a target of reproduction is not limited to the television broadcast but can also be a radio broadcast program of only an audio sound.

In the ring buffer area, the HDD 12 records and reproduces the MPEG signal in the form shown in FIG. 2. A write position WP shown in FIG. 2 indicates a present recording position in the ring buffer area, and a read position RP indicates a present reproducing position in the area. As shown by blank arrows, each of WP and RP is independently and gradually moved from a head position to a last position of the ring buffer area and, when it reaches the last, it is returned to the head position and moved again toward the last position. That is, in the ring buffer area, the information recording and reproduction are continuously and circularly executed from the head position of the area to the last position. Since the information recording is always performed by overwriting in the ring buffer area, the program recorded in the ring buffer area is not permanently stored. The program recorded in the memory area, on the other hand, is permanently stored until a program erasing command is executed.

That is, the ring buffer area where the broadcast program is temporarily recorded and the memory area where the broadcast program can be permanently recorded are provided on the hard disk 120.

Between a reproduction MPEG signal RM supplied from the HDD 12 and the MPEG signal M1 supplied from the tuner 11, the selector 13 alternatively selects the signal according to a selection signal supplied from the system control circuit 10 and supplies it to an MPEG decoder 17. The MPEG decoder 17 performs an MPEG decoding process to the MPEG signal supplied from the selector 13, thereby obtaining a video signal and supplying it to a selector 18 as a video signal D_{AV}. An OSD (On Screen Display) image generating circuit 19 generates a message image signal D_{C} for displaying images according to various message display commands supplied from the system control circuit 10 and supplies it to the selector 18. Between the video signal D_{AV} and the message image signal D_{C}, the selector 18 alternatively selects the signal according to the selection signal supplied from the system control circuit 10 and supplies it to a display device 200. The display device 200 displays an image based on the video signal D_{AV} or the message image signal D_{C} supplied from the hard disk recorder 100.

A date/time measuring timer 21 measures the today's date and the present time and supplies date/time information TD showing them to the system control circuit 10 and a timer recording control circuit 22.

The timer recording control circuit 22 retrieves program recording reservation information (a channel number of a program whose recording is to be reserved, a scheduled broadcast date of the program, a broadcast start time, and a broadcast end time) supplied from an operating apparatus 20 and stores it into a program reservation memory (not shown). The program recording reservation information is properly set by operating the operating apparatus 20 by the user. If the scheduled broadcast date of the program and the broadcast start time shown in the program recording reservation information coincide with those shown in the date/time information TD, the timer recording control circuit 22 supplies a timer recording signal TMS to the system control circuit 10 for a period of time until the broadcast end time. At the same time, the timer recording control circuit 22 supplies a channel number shown by the program recording reservation information to the system control circuit 10 as a timer reservation channel signal TM_{CH}.

That is, the timer recording control circuit 22 supplies the timer recording signal TMS and timer reservation channel signal TM_{CH} to the system control circuit 10 in order to record the program broadcasted in the channel number on the scheduled broadcast date and its program broadcast time zone shown in the program recording reservation information.

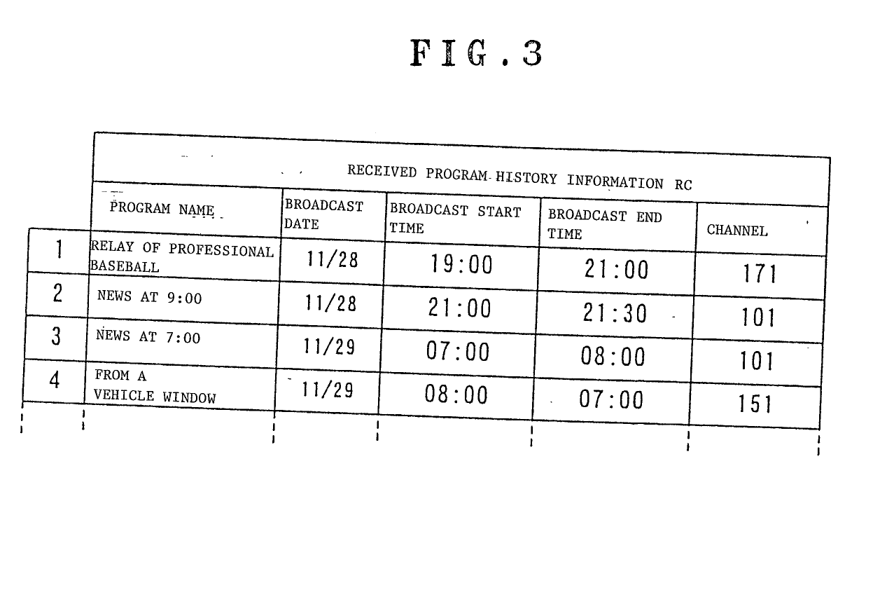

A received program history memory 23 stores received program history information RC supplied from the system control circuit 10. The received program history information RC denotes the name of the program received by the tuner 11 and the broadcast date, broadcast start time, broadcast end time, and channel number of the program. The information indicative of those program name, broadcast date, broadcast start time, broadcast end time, and channel number is additionally written into the received program history memory 23 so as to correspond to each other every program as shown in FIG. 3.

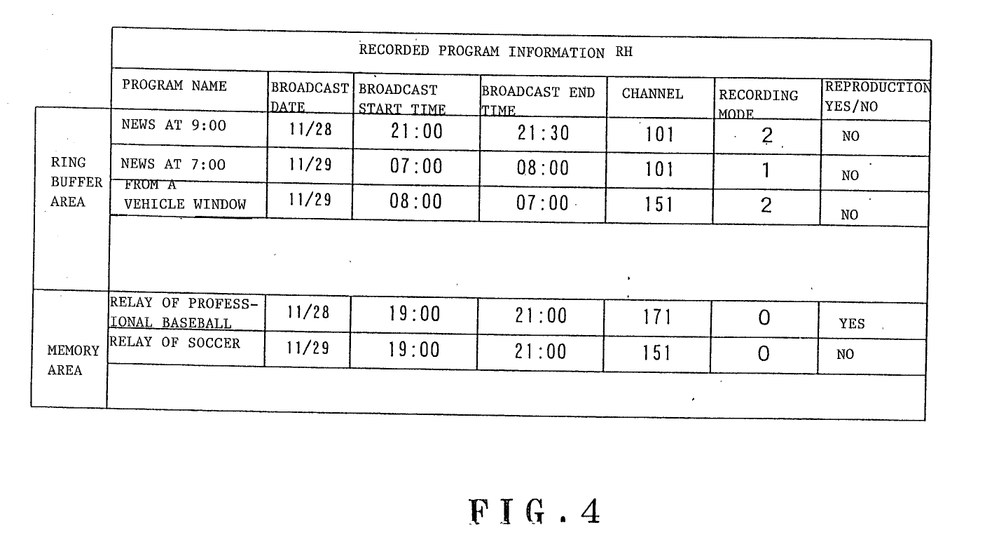

A recorded program information memory 24 stores recorded program information RH supplied from the system control circuit 10. The recorded program information RH is information showing the names of the programs recorded in the ring buffer area and memory area in the HDD 12 and the broadcast date, broadcast start time, broadcast end time, channel number, recording mode, and a reproduction yes/no flag of each of the programs, respectively. The recording mode is information showing a recording method which is used when the program is recorded. For example, in accordance with the recording command operation from the user, in case of the program which was directly recorded, “0” is written as a recording mode, in case of the timer recording, “1” is written, and in case of the program which was automatically recorded by the history recording according to the invention, “2” is written. The reproduction yes/no flag is a flag showing whether the program has been reproduced at least once after it had been recorded to the HDD 12 or not. For example, if the reproduction is not performed yet, a logic level “0” is written as a reproduction yes/no flag. If the reproduction has been performed at least once, a logic level “1” is written. The information representing the program name, broadcast date, broadcast start time, broadcast end time, channel number, recording mode, and reproduction yes/no flag of the program is additionally written in the recorded program information memory 24 in correspondence to each program as shown in FIG. 4. The recorded program information regarding the programs recorded in the ring buffer area in the HDD 12 and the recorded program information regarding the programs recorded in the memory area are classified as shown in FIG. 4 and stored in the recorded program information memory 24, respectively.

The operating apparatus 20 receives various operation command operations from the user and supplies various operation signals according to those operations to the system control circuit 10 or timer recording control circuit 22. As an operating apparatus 20, it is possible to use a remote controller which is provided separately outside the casing of the hard disk recorder 100.

Various operations (television monitoring operation, continuous recording operation, time-shift reproducing operation, program storing operation, timer recording operation, history recording operation) of the hard disk recorder 100 will be described below.

(1) Television Monitoring Operation

In case of monitoring the program during the broadcast, first, the user executes the designating operation of a desired channel by using the operating apparatus 20. In accordance with this operation, the operating apparatus 20 supplies a television monitor command signal to the system control circuit 10. In response to the TV monitor command signal, the system control circuit 10 supplies the channel designation signal CH showing the desired channel to the tuner 11. At the same time, the system control circuit 10 supplies a selection signal for alternatively transferring the MPEG signal M1 generated from the tuner 11 to the MPEG decoder 17 to the selector 13. The system control circuit 10 further supplies a selection signal for alternatively transferring the video signal D_{AV} supplied from the MPEG decoder 17 to the display device 200 to the selector 18. By the operation as mentioned above, the MPEG signal M1 obtained by receiving and demodulating by the tuner 11 is decoded to the video signal D_{AV} by the MPEG decoder 17 and, thereafter, supplied to the display device 200. The display device 200, thus, displays the digital broadcast program of the desired channel received by the tuner 11 as an image in a real-time manner. In this case, the system control circuit 10 retrieves the received program information PI supplied from the tuner 11, that is, the information representing the name, broadcast date, broadcast start time, broadcast end time, and channel number of the received program. The system control circuit 10 stores the retrieved received program information PI as received program history information RC into the received program history memory 23 as shown in FIG. 3.

(2) Continuous Recording Operation

When the user sequentially and continuously records at random the programs broadcasted by preset specific channels, he executes the continuous recording command operation by using the operating apparatus 20. In accordance with the continuous recording command operation, the operating apparatus 20 supplies a continuous recording command signal to the system control circuit 10. In response to the continuous recording command signal, the system control circuit 10 supplies a ring buffer recording command signal to the HDD 12. In response to the ring buffer recording command signal, the HDD 12 records the MPEG signal M1 (or M2) obtained by the reception and demodulation by the tuner 11 into the ring buffer area on the hard disk 120 as shown in FIG. 2. That is, the HDD 12 sequentially records the MPEG signal M1 (or M2) from the head position to the last position of the ring buffer area. Upon completion of the recording until the last position of the ring buffer area, the HDD 12 is returned to the head position and records the MPEG signal M1 (or M2) therefrom again. Until the user executes the continuous recording stop command operation, the HDD 12 repetitively executes the recording operation in the ring buffer area. Each of the programs broadcasted by the specific channels which have been preset by the user is, therefore, continuously recorded into the ring buffer area. The system control circuit 10 stores various information (program name, broadcast date, broadcast start time, broadcast end time, channel number, recording mode, and reproduction yes/no flag) regarding the programs recorded in the ring buffer area on the hard disk 120 as mentioned above into the recorded program information memory 24 as shown in FIG. 4.

(3) Time-shift Reproducing Operation

In case of reproducing a desired recorded program during the execution of the continuous recording operation, the user executes the designating and reproducing command operations of the desired program by using the operating apparatus 20. In accordance with the operation, the operating apparatus 20 supplies a reproducing command signal to the system control circuit 10. In response to the reproducing command signal, the system control circuit 10 supplies the information indicative of the position in the ring buffer area where the desired program designated by the user has been recorded and a reproduction start command signal to the HDD 12. The HDD 12, thus, reads the information from the position in the ring buffer area where the desired program has been recorded and supplies the obtained reproduction MPEG signal RM to the selector 13. The system control circuit 10 supplies the selection signal for alternatively transferring the reproduction MPEG signal RM generated from the HDD 12 to the MPEG decoder 17 to the selector 13. By the operation, the MPEG decoder 17 supplies the video signal D_{AV} obtained by demodulating the reproduction MPEG signal RM to the display device 200 via the selector 18. At this time, the system control circuit 10 alternately executes the reproducing operation and the continuous recording operation as mentioned above every predetermined interval. The system control circuit 10, thus, executes what is called a time-shift reproduction such that while the program which is being broadcasted at resent is recorded, the program which has already been recorded is reproduced. In this process, the system control circuit 10 extracts the recorded program information corresponding to the program reproduced as mentioned above from the recorded program information memory 24 and rewrites the reproduction yes/no flag into the logic level “1”.

(4) Program Storing Operation

In case of recording the broadcast program received by the tuner 11 at the present point of time, the user executes the recording command operation by using the operating apparatus 20. In accordance with the operation, the operating apparatus 20 supplies a program storage command signal to the system control circuit 10. In response to the program storage command signal, the system control circuit 10 supplies a storage recording command signal for recording the MPEG signal M1 (or M2) obtained by receiving and demodulating by the tuner 11 into the memory area on the hard disk 120 as shown in FIG. 2 to the HDD 120. In this instance, the system control circuit 10 stores the various information (program name, broadcast date, broadcast start time, broadcast end time, channel number, recording mode, and reproduction yes/no flag) regarding the programs recorded in the memory area on the hard disk 120 as mentioned above into the recorded program information memory 24 as shown in FIG. 4. “0” is written as a recording mode with respect to the program recorded by the program storing operation.

(5) Timer Recording Operation

When performing the timer recording, the user enters the channel number of the program whose recording is to be reserved and the scheduled broadcast date, broadcast start time, and broadcast end time of the program by using the operating apparatus 20. The various information entered as mentioned above is, thus, stored as program recording reservation information into a program reservation memory built in the timer recording control circuit 22. If the scheduled broadcast date stored in the program reservation memory coincides with the date shown by the date/time information TD and, further, the broadcast start time of the program coincides with the present time, the timer recording control circuit 22 continuously supplies the timer recording signal TMS to the system control circuit 10 for a period of time until the broadcast end time. At the same time, the timer recording control circuit 22 supplies the channel number shown by the program recording reservation information to the system control circuit 10 as a timer reservation channel signal TM_{CH}. When the timer recording signal TMS and timer reservation channel signal TM_{CH} are supplied, the system control circuit 10 supplies the channel designation signal CH for receiving the program of the channel shown by the timer reservation channel signal TM_{CH} to the tuner 11. Further, the system control circuit 10 supplies the storage recording command signal for recording the program received by the tuner 11 as mentioned above into the memory area on the hard disk 120 as shown in FIG. 2 to the HDD 12. The program whose recording has previously been reserved by the user is, consequently, automatically recorded into the memory area on the hard disk 120 on the scheduled broadcast date and time of the program. In this instance, the system control circuit 10 stores the various information regarding the program recorded in the memory area on the hard disk 120 as mentioned above, that is, each of the program name, broadcast date, broadcast start time, broadcast end time, channel number, recording mode, and reproduction yes/no flag into the recorded program information memory 24 as shown in FIG. 4. “1” indicative of the timer recording is written as a recording mode.

(6) History Recording Operation

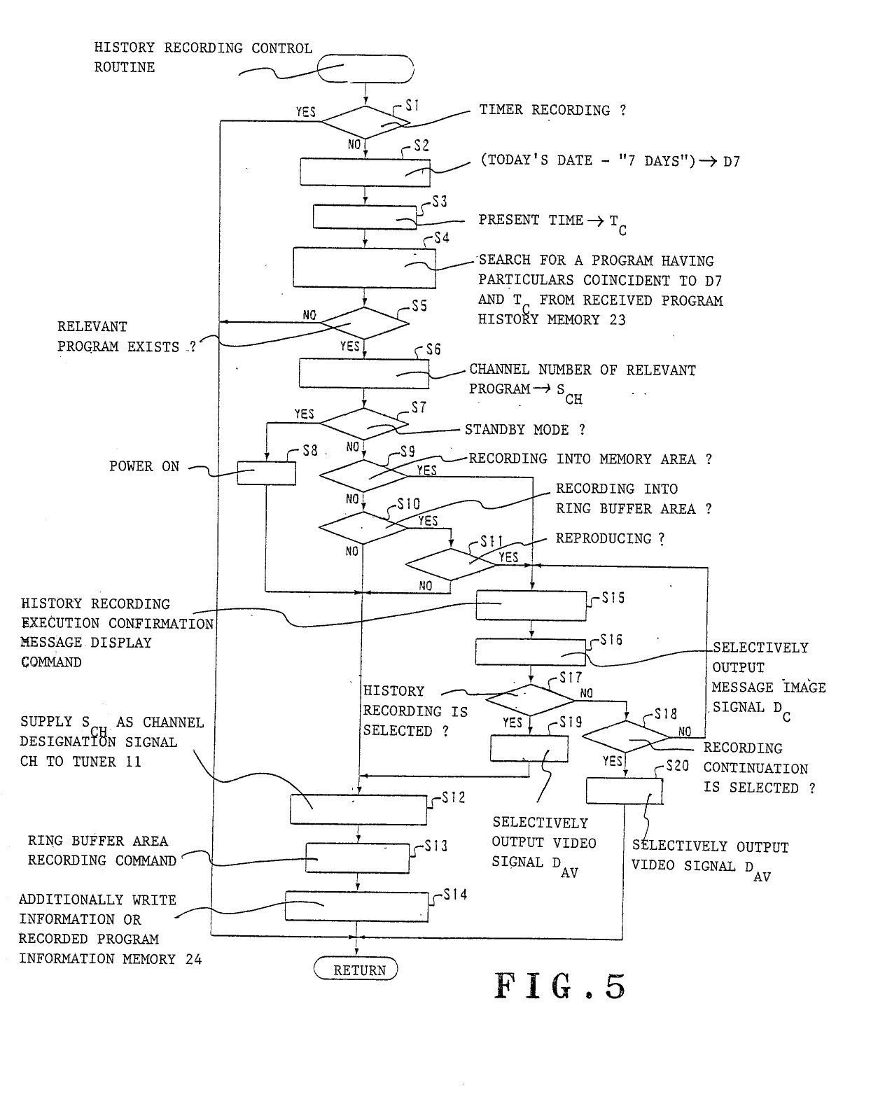

If the user has set the hard disk recorder 100 to the history recording mode by using the operating apparatus 20, the system control circuit 10 executes a history recording control routine as shown in FIG. 5 at predetermined intervals.

In FIG. 5, first, the system control circuit 10 discriminates whether the timer recording signal TMS has been supplied from the timer recording control circuit 22 or not (step S1). That is, whether the timer recording is being executed at present or not is discriminated in step S1. If it is determined in step S1 that the timer recording signal TMS has been supplied, that is, the timer recording is being executed, the system control circuit 10 exits from the history recording control routine, is returned to the execution of a main control flow (not shown) for performing the various operations as mentioned above, and continues the timer recording operation.

If it is determined in step S1 that the timer recording signal TMS is not supplied, that is, the timer recording is not executed, the system control circuit 10 fetches the date/time information TD from the date/time measuring timer 21. The system control circuit 10 stores a date that is one week before the today's date indicated by the date/time information TD into a built-in register (not shown) as a program monitoring date D7 (step S2). Subsequently, the system control circuit 10 stores the present time represented by the date/time information TD into the built-in register as a present time T_{C} (step S3). The system control circuit 10 searches for a program having a broadcast date coincides with the program monitoring date D7 and the broadcast start time coincides with the present time T_{C} from among the received program history information stored in the received program history memory 23 (step S4). The system control circuit 10 discriminates whether or not the program having a broadcast date coincides with the program monitoring date D7 and the broadcast start time coincides with the present time T_{C} has been stored in the received program history memory 23 as a search result in step S4 (step S5). If it is determined in step S5 that the program having a broadcast date coincides with the program monitoring date D7 and the broadcast start time coincides with the present time T_{C} has not been stored in the received program history memory 23, the system control circuit 10 exits from the history recording control routine and is returned to the execution of the main control flow for performing the various operations as mentioned above.

If it is determined in step S5 that the program having a broadcast date coincides with the program monitoring date D7 and the broadcast start time coincides with the present time T_{C} has been stored in the received program history memory 23, the system control circuit 10 stores the channel number of the program as a selected station channel number S_{CH} into the built-in register (step S6). The system control circuit 10 discriminates whether the hard disk recorder 100 is in a standby mode or not (step S7). That is, whether the hard disk recorder 100 is in the standby mode where although a main power source is ON, a power supply to other modules excluding the system control circuit 10, operating apparatus 20, date/time measuring timer 21, and timer recording control circuit 22 is shut off or not is discriminated. If it is determined in step S7 that the hard disk recorder 100 is in the standby mode, the system control circuit 10 forcibly turns on the power source of the hard disk recorder 100 and resets the standby mode (step S8). By the execution of step S8, power voltages are supplied to all modules including the HDD 12.

If it is determined in step S7 that the hard disk recorder 100 is not in the standby mode, the system control circuit 10 discriminates whether the HDD 12 is recording the program into the memory area on the hard disk 120 or not (step S9). If it is determined in step S9 that the HDD 12 is not recording the program into the memory area on the hard disk 120, the system control circuit 10 subsequently discriminates whether the HDD 12 is recording the program into the ring buffer area on the hard disk 120 or not (step S10). If it is determined in step S10 that the HDD 12 is recording the program into the ring buffer area on the hard disk 120, the system control circuit 10 subsequently discriminates whether the HDD 12 is executing the time-shift reproducing operation or not (step S11).

If it is determined in step S11 that the HDD 12 is not executing the time-shift reproducing operation, or if it is determined in step S10 that the HDD 12 is not recording the program into the ring buffer area, or after the turn-on of the power source in step S8, the system control circuit 10 executes the following processes in steps S12 and S13. That is, first, the system control circuit 10 supplies the selected station channel number S_{CH} as a channel designation signal CH to the tuner 11 (step S12). By the execution of step S12, the tuner 11 receives the broadcast wave of the same channel as the channel received in the same time zone of one week before and supplies the obtained MPEG signal M1 (or M2) to the HDD 12. The system control circuit 10 subsequently supplies a ring buffer recording command signal for recording the MPEG signal M1 (or M2) into the ring buffer area on the hard disk 120 to the HDD 12 (step S13).

By the execution of steps S12 and S13, therefore, what is called a history recording such that the user automatically station-selects the program broadcasted by the same channel as that selected in the present time zone of one week before and records it is performed.

After the execution of step S13, based on the received program information PI supplied from the tuner 11, the system control circuit 10 generates the recorded program information RH (program name, broadcast date, broadcast start time, broadcast end time, channel number, recording mode, and reproduction yes/no flag) regarding the programs recorded in the ring buffer area. The recorded program information RH is stored into the recorded program information memory 24 as shown in FIG. 4 (step S14). In this case, “2” indicative of the history recording is written as a recording mode in the recorded program information RH.

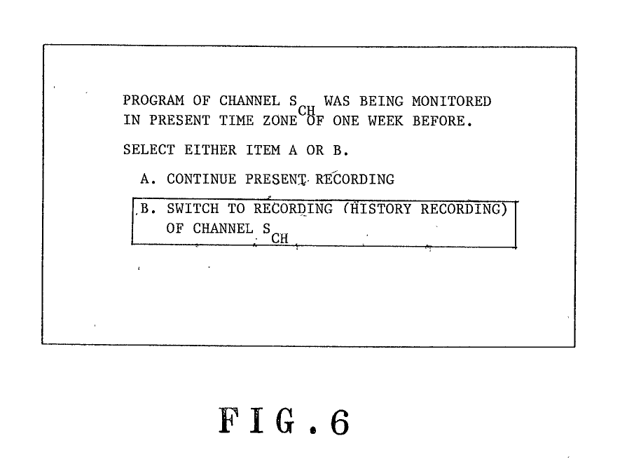

If it is determined in step S11 that the HDD 12 is executing the time-shift reproducing operation, or if it is determined in step S9 that the HDD 12 is recording the program into the memory area on the hard disk 120, the system control circuit 10 supplies a history recording execution confirmation message display command to the OSD image generating circuit 19 (step S15). That is, the system control circuit 10 notifies the fact that the user was monitoring the program of the channel shown by the selected station channel number S_{CH} in the present time zone of one week before, and supplies the display command of the history recording execution confirmation message as a notification for allowing the user to select whether the program is recorded or the recording at the present point of time is continued to the OSD image generating circuit 19. Subsequently, the system control circuit 10 supplies the selection signal for alternatively transferring the message image signal D_{C} generated from the OSD image generating circuit 19 to the display device 200 to the selector 18 (step S16). By the execution of steps S15 and S16, the display device 200 displays, for example, a history recording execution confirmation message image as shown in FIG. 6. At this time, by operating the operating apparatus 20, the user selects either an item A or an item B in FIG. 6. When continuing the recording of the present program without any change, the user selects the item A. When switching from the recording of the present program to the recording of the program represented by the selected station channel number S_{CH} (history recording), he/she selects the item B. Subsequently, the system control circuit 10 discriminates whether or not the user has selected the item B, that is, “history recording” (step S17). If it is determined in step S17 that the item B is not selected, the system control circuit 10 discriminates whether or not the user has selected the item A, that is, “continuation of the recording” (step S18). If it is decided in step S18 that “continuation of the recording” is not selected, the system control circuit 10 returns to the execution of step S15 and repetitively executes the operations as mentioned above. That is, if either the item A or B as shown in FIG. 6 is not selected, the message image display is continuously executed.

If it is decided in step S17 that the item B has been selected, that is, if the execution of the history recording as mentioned above is selected, the system control circuit 10 supplies the selection signal for alternatively transferring the video signal D_{AV} generated from the MPEG decoder 17 to the display device 200 to the selector 18 (step S19). After the execution of step S19, the system control circuit 10 advances to the execution of step S12 and executes the history recording as mentioned above.

That is, if the broadcast start time of the program monitored by the user on the day of one week before comes during the recording to the memory area or during the time-shift reproduction, the user side is notified of the channel of the program and the history recording execution confirmation message is displayed in order to allow the user side to select either the mode to continue the present recording state or the mode to switch the recording mode to the history recording. Only when the history recording is selected, the program broadcast by the same channel as that selected in the present time zone of one week before is automatically station-selected and recorded.

If the item A is selected, that is, if the mode to continue the present recording operation is selected in step S18, the system control circuit 10 supplies the selection signal for alternatively transferring the video signal D_{AV} generated from the MPEG decoder 17 to the display device 200 to the selector 18 (step S20). After the execution of step S20 or step S14, the system control circuit 10 exits from the history recording control routine and returns to the execution of the main control flow for performing the various operations as mentioned above. For example, if the history recording control routine is executed during the program storing operation as mentioned above, the program storing operation is restarted. If the history recording control routine is executed during the time-shift reproduction, the time-shift reproduction is restarted.

As mentioned above, by setting the hard disk recorder 100 to the history recording mode, the program broadcasted by the same channel as that selected in the present time zone of one week before is automatically station-selected and recorded.

According to the history recording mode, even if the user forgets to monitor a desired program which he habitually watches among the programs of the same titles which are periodically (one week) broadcasted, the desired program is automatically recorded, so that the missing of the desired program is avoided.

Although only one tuner for receiving the broadcast programs has been installed in the hard disk recorder 100 shown in FIG. 1, a plurality of tuners can be also installed.

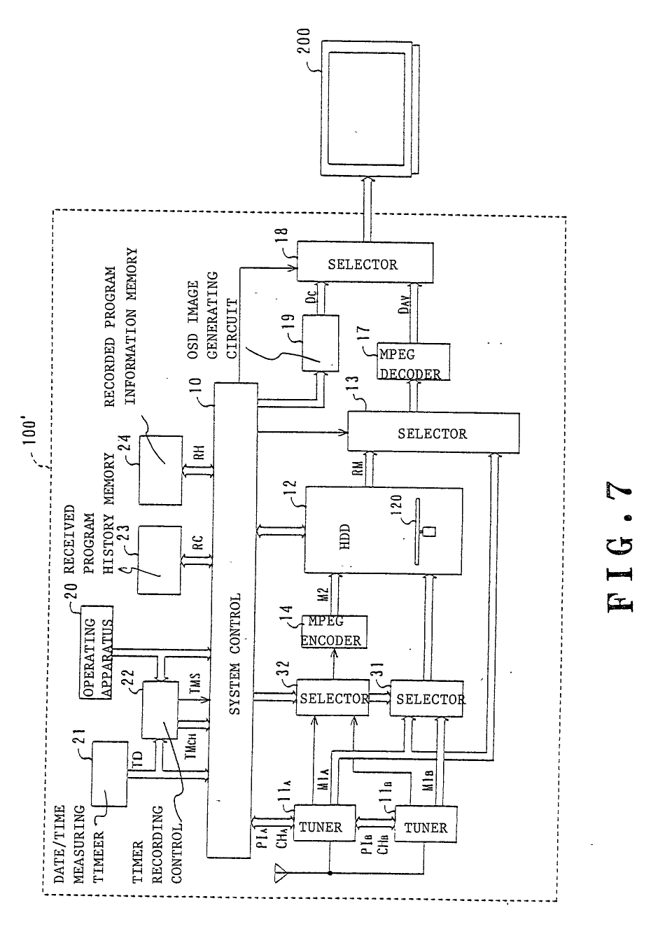

FIG. 7 is a diagram showing a construction of a hard disk recorder 100′ in which two tuners are installed.

In FIG. 7, other constructions except for tuners 11_{A} and 11_{B} and selectors 31 and 32 are substantially the same as those in FIG. 1. The operation of the hard disk recorder 100′ shown in FIG. 7, therefore, will be described hereinbelow mainly with respect to the operations of the tuners 11_{A} and 11_{B} and selectors 31 and 32.

The tuner 11_{A} receives a digital broadcast wave of the channel according to a channel designation signal CH_{A} supplied from the system control circuit 10. In this process, the tuner 11_{A} obtains an MPEG signal by demodulating the received digital broadcast wave and supplies it as an MPEG signal M1_{A} to each of the selectors 31 and 13. Further, during this period of time, the tuner 11_{A} extracts information representing the name, broadcast date, broadcast start time, broadcast end time, and channel number of the received program from an electronic program guide information signal multiplexed to the received broadcast wave and supplies it as received program information PI_{A} to the system control circuit 10. When the channel designation signal CH_{A} to designate a channel of analog television broadcast (NTSC system, PAL system, or SECAM system) is supplied, the tuner 11_{A} receives an analog television broadcast wave of the designated channel. In this case, the tuner 11_{A} supplies a television signal obtained by demodulating the received analog television broadcast wave to the selector 32. Further, the tuner 11_{A} extracts the information showing the name, broadcast date, broadcast start time, broadcast end time, and channel number of the received broadcast program from the electronic program guide information signal and supplies it as received program information PI_{A} to the system control circuit 10.

The tuner 11_{B} receives a digital broadcast wave of the channel according to a channel designation signal CH_{B} supplied from the system control circuit 10. In this process, the tuner 11_{B} obtains an MPEG signal by demodulating the received digital broadcast wave and supplies it as an MPEG signal M1_{B} to each of the selector 31. Further, during the period of time, the tuner 11_{B} extracts information showing a name, a broadcast date, a broadcast start time, a broadcast end time, and a channel number of the received program from an electronic program guide information signal multiplexed to the received broadcast wave and supplies it as received program information PI_{B} to the system control circuit 10. When the channel designation signal CH_{B} to designate a channel of analog television broadcast (NTSC system, PAL system, or SECAM system) is supplied, the tuner 11_{B} receives an analog television broadcast wave of the designated channel. In this state, the tuner 11_{B} supplies a television signal obtained by demodulating the received analog television broadcast wave to the selector 32. Further, the tuner 11_{B} extracts the information representing the name, broadcast date, broadcast start time, broadcast end time, and channel number of the received broadcast program from the electronic program guide information signal and supplies it as received program information PI_{B} to the system control circuit 10.

Between the MPEG signals M1_{A} and M1_{B} supplied from the tuners 11_{A} and 11_{B} the selector 31 alternatively selects the signal according to the selection signal supplied from the system control circuit 10 and supplies it to the HDD 12. Between the TV signals supplied from the tuners 11_{A} and 11_{B}, the selector 32 alternatively selects the signal according to the selection signal supplied from the system control circuit 10 and supplies it to the MPEG encoder 14.

In each of the television monitoring operation, continuous recording operation, time-shift reproducing operation, program storing operation, and timer recording operation as mentioned above, the system control circuit 10 supplies the selection signal for allowing the user to select the MPEG signal M1_{A} (or M2_{A})generated from the tuner 11A to each of the selectors 31 and 32.

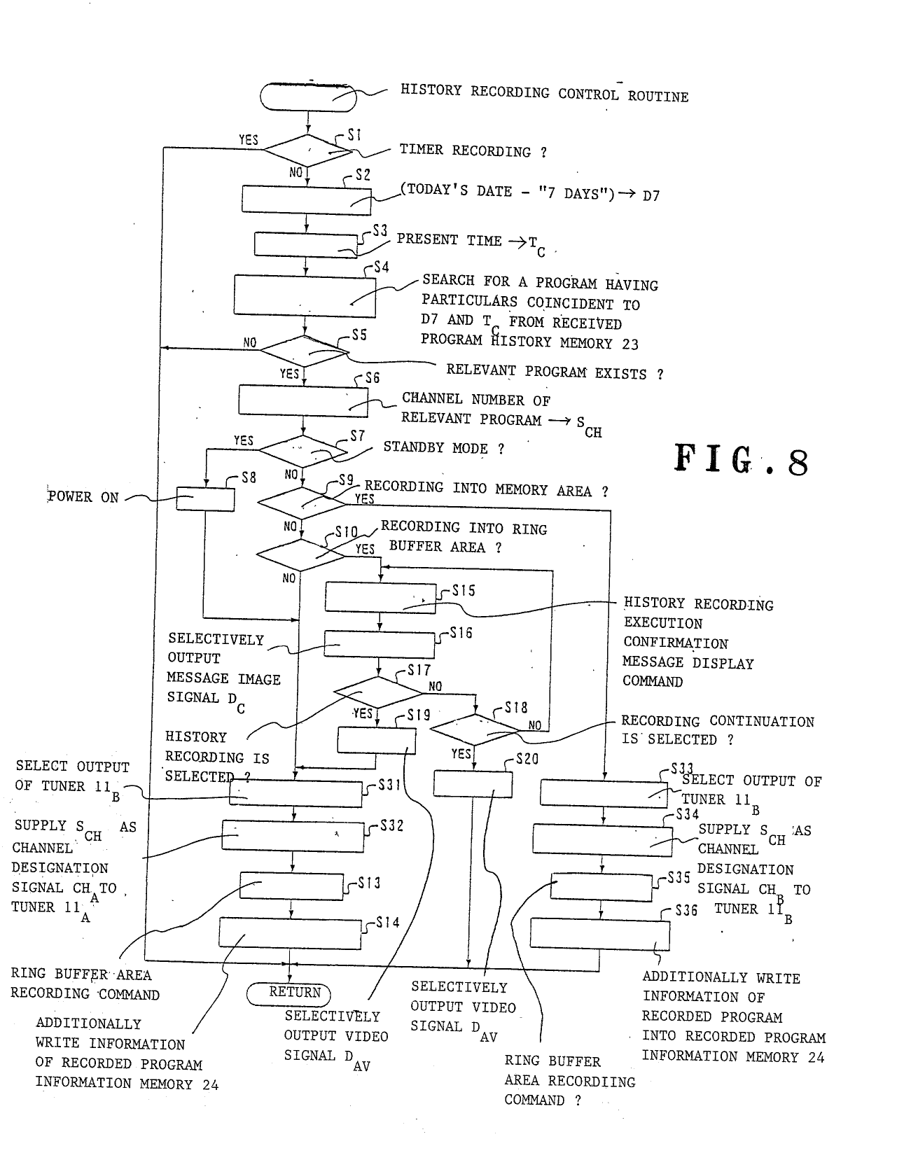

FIG. 8 is a diagram showing the history recording control routine which is executed by the system control circuit 10 at predetermined intervals when the hard disk recorder 100′ as shown in FIG. 7 has been set to the history recording mode.

Since the control in steps S1 to S8 shown in FIG. 8 is substantially the same as that shown in FIG. 5, only the operations in step S9 and subsequent steps will be explained hereinbelow.

If it is determined in step S7 that the hard disk recorder 100 is not in the standby mode, the system control circuit 10 discriminates whether the HDD 12 is recording the program into the memory area on the hard disk 120 or not (step S9). If it is determined in step S9 that the HDD 12 is not recording the program into the memory area on the hard disk 120, the system control circuit 10 subsequently discriminates whether the HDD 12 is recording the program into the ring buffer area on the hard disk 120 or not (step S10). If it is determined in step S10 that the HDD 12 is recording the program into the ring buffer area on the hard disk 120, the system control circuit 10 executes the following processes in steps S31, S32, S13, and S14.

That is, first, the system control circuit 10 supplies a selection signal for selecting the MPEG signal M_{A} (or M2_{A}) generated from the tuner 11_{A} to each of the selectors 31 and 32 (step S31). Subsequently, the system control circuit 10 supplies the selected station channel number S_{CH} as a channel designation signal CH_{A} to the tuner 11_{A} (step S32). By the execution of step S32, the tuner 11_{A} receives the broadcast wave of the same channel as the channel received in the same time zone of one week before and supplies the obtained MPEG signal M1 (or M2) to the HDD 12. The system control circuit 10 supplies a ring buffer recording command signal for recording the obtained MPEG signal M1 (or M2) into the ring buffer area on the hard disk 120 to the HDD 12 (step S13).

By the execution of steps S31, S32, and S13, therefore, what is called a history recording such that the program broadcasted by the same channel as the channel which was selected by the user in the present time zone of one week before is automatically station-selected and recorded is executed.

After the execution of step S13, on the basis of the received program information PI_{A} supplied from the tuner 11_{A}, the system control circuit 10 generates the recorded program information RH (program name, broadcast date, broadcast start time, broadcast end time, channel number, recording mode, and reproduction yes/no flag) regarding the programs recorded in the ring buffer area. The recorded program information RH is additionally written into the recorded program information memory 24 as shown in FIG. 4 (step S14). “2” indicative of the history recording is written as a recording mode in the recorded program information RH.

If it is decided in step S10 the HDD 12 is recording the program into the ring buffer area at present, the system control circuit 10 supplies the history recording execution confirmation message display command to the OSD image generating circuit 19 (step S15). That is, the system control circuit 10 notifies the fact that the user was monitoring the program of the channel shown by the selected station channel number S_{CH} in the present time zone of one week before, and supplies the history recording execution confirmation message display command for allowing the user to select whether the program is recorded or the recording at the present point of time is continued to the OSD image generating circuit 19. Subsequently, the system control circuit 10 supplies the selection signal for alternatively transferring the message image signal D_{C} generated from the OSD image generating circuit 19 to the display device 200 to the selector 18 (step S16). By the execution of steps S15 and S16, the display device 200 displays, for example, the history recording execution confirmation message image as shown in FIG. 6. At this time, by operating the operating apparatus 20, the user selects either an item A or an item B in FIG. 6. In case of continuing the present program recording as it is, the user selects the item A. When switching from the recording of the present program to the recording of the program indicated by the selected station channel number S_{CH} (history recording), he/she selects the item B. Subsequently, the system control circuit 10 discriminates whether the user has selected the item B, that is, “history recording” or not (step S17). If it is decided in step S17 that the item B is not selected, the system control circuit 10 discriminates whether the user has selected the item A, that is, “recording continuation” or not (step S18). If it is decided in step S18 that “continuation of the recording” is not selected, the system control circuit 10 returns to the execution of step S15 and repetitively executes the operations as mentioned above. That is, if either the item A or B as shown in FIG. 6 is not selected, the message image display is continuously executed.

If it is decided in step S17 that the item B has been selected, that is, if the execution of the history recording as mentioned above is selected, the system control circuit 10 supplies the selection signal for alternatively transferring the video signal D_{AV} generated from the MPEG decoder 17 to the display device 200 to the selector 18 (step S19). After the execution of step S19, the system control circuit 10 proceeds to the execution of step S31 and executes the history recording as mentioned above.

That is, if the broadcast start time of the program monitored by the user on the day of one week before comes during the recording operation to the ring buffer area on the hard disk 120, the user side is notified of the channel of the program as shown in FIG. 6. Further, the history recording execution confirmation message as shown in FIG. 6 is displayed in order to allow the user side to select either the mode to execute the recording of the program, that is, the mode to execute the history recording or the mode to continue the present recording. Only when the history recording is selected, the program broadcasted by the same channel as that selected by the user in the present time zone of one week before is automatically station-selected and recorded.

If the item A is selected, that is, if the mode to continue the present recording operation is selected in step S18, the system control circuit 10 supplies the selection signal for alternatively transferring the video signal D_{AV} generated from the MPEG decoder 17 to the display device 200 to the selector 18 (step S20).

If it is decided in step S9 that the HDD 12 is recording the program into the memory area on the hard disk 120 at present, the system control circuit 10 executes the following processes in steps S33 to S35. That is, first, the system control circuit 10 supplies a selection signal for selecting the MPEG signal M1_{B} (or M2_{B}) generated from the tuner 11_{B} to each of the selectors 31 and 32 (step S33). Subsequently, the system control circuit 10 supplies the selected station channel number S_{CH} as a channel designation signal CH_{B} to the tuner 11_{B} (step S34). By the execution of step S34, the tuner 11_{B} receives the broadcast wave of the same channel as the channel received in the same time zone of one week before and supplies the obtained MPEG signal M1 (or M2) to the HDD 12. The system control circuit 10 supplies the ring buffer recording command signal for recording the obtained MPEG signal M1 (or M2) into the ring buffer area on the hard disk 120 to the HDD 12 (step S35). According to the execution of steps S33 to S35, what is called a history recording such that the program broadcasted by the same channel as the channel which was selected by the user in the present time zone of one week before is automatically station-selected and recorded is executed.

After the execution of step S35, based on the received program information PI_{B} supplied from the tuner 11_{B}, the system control circuit 10 generates the recorded program information RH (program name, broadcast date, broadcast start time, broadcast end time, channel number, recording mode, and reproduction yes/no flag) regarding the programs recorded in the ring buffer area. The recorded program information RH is additionally written into the recorded program information memory 24 as shown in FIG. 4 (step S36). “2” indicative of the history recording is written as a recording mode in the recorded program information RH.

After the execution of step S14, S20, or S36, the system control circuit 10 exits from the history recording control routine and is returned to the execution of the main control flow for performing the various operations as mentioned above. For example, in the case where the history recording control routine is executed during the program storing operation as mentioned above, the program storing operation is restarted. When the history recording control routine is executed during the time-shift reproduction, the time-shift reproducing operation is restarted.

According to the hard disk recorder 10′ in which the two tuners as shown in FIG. 7 are provided, even during the recording into the memory area, the history recording (steps S33 to S35) into the ring buffer area can be executed in parallel with it.

In the embodiment described above, the channel which the user watched on the same day of one week before is automatically selected when the history recording is performed. However, the date for the selection of channel is not limited to the date of one week before. In brief, with respect to a broadcast program which is provided from a broadcast station adopting a program organization that programs of the same title are broadcasted at intervals of predetermined N periods, it is sufficient to automatically select and record the channel which the user watched on the day of N periods before.

As described in detail above, according to the broadcast program recording apparatus of the invention, the possibility of missing the desired program can be prevented since a series of programs which a user watches periodically can be automatically recorded without the need of performing the cumbersome timer recording setting operation.

This application is based on Japanese Patent Application No. 2000-382379 which is hereby incorporated by reference.

What is claimed is:

1. A broadcast program recording apparatus for recording a broadcasted program, comprising:
a receiving part for receiving a broadcast wave of a selected channel and demodulating the broadcast program;
a recording part for recording said broadcast program onto a recording medium in response to a recording start command;
a received program history memory for additionally storing data representing channel number, broadcast date, and broadcast time zone of said broadcast program received and demodulated by said receiving part in correspondence to each other;
a searching part for searching said received program history memory for a channel number of a broadcast program having a broadcast date that is precedent to today's date by a predetermined number of days and a broadcast time zone that coincides with the present time; and
a history recording control part for performing a station selection control operation to control said receiving part to receive the broadcast wave of said channel number searched out by said searching part and transmitting said recording start command to said recording part.

2. An apparatus according to claim 1, wherein said predetermined number of days corresponds to one week.

3. A broadcast program recording apparatus for recording a broadcasted program, comprising:
a recording part having a recording medium on which a ring buffer area and a memory area have been formed;
a receiving part for receiving a broadcast wave of a selected channel and demodulating the broadcast program;
a received program history memory for additionally storing data representing channel number, broadcast date, and broadcast time zone of said broadcast program received and demodulated by said receiving part in correspondence to each other;
a searching part for searching said received program history memory for a channel number of a broadcast program having a broadcast date that is precedent to today's date by a predetermined number of days and a broadcast time zone that coincides with the present time; and
a history recording control part for performing a station selection control operation to control said receiving part to receive the broadcast wave of said channel number searched out by said searching part and performing a recording control operation to control said recording part to record said broadcast program obtained by receiving by said receiving part into said ring buffer area.

4. An apparatus according to claim 3, wherein said predetermined number of days corresponds to one week.

5. An apparatus according to claim 3, further comprising a program storing part for performing a recording control operation to control said recording part to record said broadcast program obtained by receiving by said receiving part into said memory area in accordance with a recording command operation.

6. An apparatus according to claim 3 or 5, wherein
when said recording part is executing the recording operation into said memory area, said history recording control part performs a history recording execution confirmation notification to select either a mode to continue the recording operation into said memory area or a mode to execute the history recording for recording the broadcast program of the same channel number as that searched out by said searching part into said ring buffer area, and
only when said history recording is selected, said history recording is executed.

7. An apparatus according to claim 6, wherein said history recording execution confirmation notification includes a message for notifying the fact that the broadcast program of said channel number searched out by said searching part was monitored in a present time zone of one week before.

8. A broadcast program recording apparatus for recording a broadcasted program, comprising:
a recording part having a recording medium on which a ring buffer area and a memory area have been formed;
a first receiving part for receiving a broadcast wave of a first selected channel and demodulating a first broadcast program;
a second receiving part for receiving a broadcast wave of a second selected channel and demodulating a second broadcast program;
a received program history memory for additionally storing the channel number, broadcast date, and broadcast time zone of said first broadcast program in correspondence to each other;
a program storing part for performing a recording control operation to control said recording part to record said broadcast program obtained by receiving by said first receiving part into said memory area in accordance with a recording command operation;
a searching part for searching said received program history memory for a channel number of a broadcast program having a broadcast date that is precedent to today's date by a predetermined number of days and a broadcast time zone that coincides with the present time; and
a history recording control part for performing a station selection control operation to control said second receiving part to receive the broadcast wave of said channel number searched out by said searching part and performing a recording control operation to control said recording part to record said broadcast program obtained by the reception by said second receiving part into said ring buffer area.

9. An apparatus according to claim 8, wherein said predetermined number of days corresponds to one week.

10. A recording method of a broadcast program in a broadcast program recording apparatus having a receiving part for receiving a broadcast wave of a selected channel and demodulating the broadcast program and a recording part for recording said broadcast program onto a recording medium in response to a recording start command, comprising:
a received program history storing step of additionally storing data representing channel number, broadcast date, and broadcast time zone of said broadcast program received and demodulated by said receiving part into a memory in correspondence to each other;
a searching step of searching said memory for a channel number of a broadcast program having a broadcast date that is precedent to today's date by a predetermined number of days and a broadcast time zone that coincides with the present time; and
a history recording control step for performing a station selection control operation to control said receiving part to receive the broadcast wave of said channel number searched out by said searching step and transmitting said recording start command to said recording part.

11. A method according to claim 10, wherein said predetermined number of days corresponding to one week.

12. A recording method of a broadcast program in a broadcast program recording apparatus having a receiving part for receiving a broadcast wave of a selected channel and demodulating the broadcast program and a recording part having a recording medium on which a ring buffer area and a memory area have been formed, comprising:
a received program history storing step of additionally storing data representing channel number, broadcast date, and broadcast time zone of said broadcast program received and demodulated by said receiving part into a memory in correspondence to each other;
a searching step of searching said memory for a channel number of a broadcast program having a broadcast date that is precedent to today's date by a predetermined number of days and a broadcast time zone that coincides with the present time; and
a history recording control step for performing a station selection control operation is said receiving part to receive the broadcast wave of said channel number searched out by said searching step and performing a recording control operation to control said recording part to record said broadcast program obtained by receiving by said receiving part into said ring buffer area.

13. A method according to claim 12, wherein said predetermined number of days corresponds to one week.

14. A method according to claim 12, further comprising a program storing step for performing the recording control of said recording part to record said broadcast program obtained by receiving by said receiving part into said memory area in accordance with a recording command operation.

15. A method according to claim 12 or 14, wherein
in said history recording control step, when said recording part is executing the recording operation into said memory area, a history recording execution confirmation notification is performed in order to select either a mode to continue the recording operation into said memory area or a mode to execute the history recording for recording a broadcast program of the same channel number as that searched out by said searching step into said ring buffer area, and
only when said history recording is selected, said history recording is executed.

16. A method according to claim 15, wherein said history recording execution confirmation notification includes a message for notifying the fact that the broadcast program of said channel number searched out by said searching step was monitored in a present time zone of one week before.

17. A recording method of a broadcast program in a broadcast program recording apparatus having a first receiving part for receiving a broadcast wave of a first selected channel and demodulating a first broadcast program, a second receiving part for receiving a broadcast wave of a second selected channel and demodulating a second broadcast program, and a recording medium on which a ring buffer area and a memory area have been formed, comprising:
a received program history storing step of additionally storing the channel number, broadcast date, and broadcast time zone of said first broadcast program into a memory in correspondence to each other;
a program storing step for performing a recording control operation to control said recording part to record said broadcast program obtained by receiving by said first receiving part into said memory area in accordance with a recording command operation;
a searching step for searching said memory for a channel number of a broadcast program having a broadcast date that is precedent to today's date by a predetermined number of days and a broadcast time zone that coincides with the present time; and
a history recording control step of performing a station selection control operation to control said second receiving part to receive the broadcast wave of said channel number searched out by said searching step and performing a recording control operation to control said recording part to record said broadcast program obtained by the reception by said second receiving part into said ring buffer area.

18. A method according to claim 17, wherein said predetermined number of days corresponds to one week.
